(19) United States
(12) Patent Application Publication
(10) Pub. No.: US 2012/0290909 A1
(43) Pub. Date: Nov. 15, 2012

(54) METHODS AND APPARATUS OF ACCESSING RELATED CONTENT ON A WEB-PAGE

(75) Inventors: ROBERT SPEIRS, St Peter Port (GG); Deep Joshi, St Peter Port (GG)

(73) Assignee: Como IP Limited, Saint Peter Port (GG)

(21) Appl. No.: 13/286,979

(22) Filed: Nov. 1, 2011

Related U.S. Application Data
(60) Provisional application No. 61/413,818, filed on Nov. 15, 2010.

(30) Foreign Application Priority Data
Nov. 1, 2010 (GB) 1018416

(51) Int. Cl. G06F 17/00

(52) U.S. Cl. 715/205; 715/234

(57) ABSTRACT

A computer implemented method is provided that includes accessing, with a web browser, a first web-page hosted on a first server, the webpage identified by a first Uniform Resource Identifier (“URI”), associating the first URI with one or more different URIs, and displaying indicia within the web browser of the one or more associated URIs, wherein the web browser renders the web-page content from the first server, and the indicia is rendered by a software module from a source separate from the host web-page, the indicia including a link to the associated URI. Numerous other aspects are provided.

### REFERENCE TO RELATED APPLICATIONS

This application claims priority from GB Patent Application Serial No. 1018416.6, filed Nov. 1, 2010, which is incorporated by reference herein in its entirety for all purposes.

This application also claims the benefit of U.S. Provisional Patent Application Ser. No. 61/413,818, filed Nov. 15, 2010, which is incorporated by reference herein in its entirety for all purposes.

### BACKGROUND

The present invention relates to a method and apparatus for a user whilst viewing a web-page over the internet to access related content. The invention does not require the host of a web-page to insert code into the web-page nor does it require the user to leave the web-page they are viewing.

It is known on web-pages to provide links to related content via the use of hyperlinks. When the user clicks on the hyperlink their web browser is directed towards the Uniform Resource Identifier (“URI”) that is defined by the hyperlink. Hyperlinks are often used to direct the user to related content or references. Such hyperlinks can only be encoded into the web-page by the host of the web-page. A user who is viewing the web-page therefore will only have direct access to hyperlinks chosen by the web-page creator. Such hyperlinks are limited to the knowledge and intent of the web-page owner. Typically, the web-page owner may only link related stories which appear on their website so that they do not send users away from their website. Therefore, proprietary interests and ignorance on the part of the web-page creator may limit the choices available to the user.

It is also known when browsing the internet to view related content to what is currently being viewed. For example, in some search engines it is known to provide a link to similar or related content next to a search result. This allows further related content to be displayed. However, when browsing any web-page which is not on a search engine, other than through the aforementioned hyperlinks, it is not possible to easily view related content. If a web user wishes to view related content they exit the web-page, access a search engine and manually input or cut and paste the address of the page viewed or keywords to find related pages. If they see a hyperlink of interest they may find the address to which it is directed (such as by right clicking the hyperlink and accessing its properties or by clicking the link and opening a new page) and then insert this address or related keywords into a search engine. Such a process provides time consuming and inefficient man machine interface, and requires a significant number of steps on the user's computer and a number of communications with web servers each of which cause a computational or bandwidth burden.

It is known in the context of advertising to automatically highlight keywords or phrases, in a web-page, and provide links to an external website which may, for example, offer a product for sale. For example, if the web-page contains identified keywords such as “DVD” and “film” the instances of these words can be automatically detected and links provided to external web-pages which offer films and DVDs for sale. Such functionality is embedded into the web-page as source code, via for example a script for an advertising server. Therefore, such functionality requires the web-page creator to code these scripts into their web-pages. Such coding can be repetitive and prone to errors. Furthermore, such functionality can only be provided if the creator of the web-page inserts the appropriate coding into the web-page. The web-page creator, therefore, has total control and a third party is unable to provide access to related web-pages.

Therefore, it is desirable to have a system that finds or provides access to related content/web-pages for a given web-page, that is easy and quick to use and does not require the web-page host/creator to alter, or introduce new source code to the web-page.

### SUMMARY

To address this and other problems of the prior art the invention seeks in the first aspect to provide a system for displaying related content on a given web-page, without requiring the web-page host to introduce any specific source code to the web-page.

According to a first aspect of the invention there is provided a computer implemented method comprising the steps of: accessing, with a web browser, a first host web-page hosted on a first server, the web-page identified by a first URI; associating the first URI with one or more different URIs; displaying indicia, within the web browser and/or operating system, of one or more associated URIs, wherein the web browser renders the web-page content from the first server, and the indicia are rendered by a software module from a source separate from the host web-page, the indicia comprising links to the associated URI.

According to a second aspect of the invention there is provided a computer implemented method comprising the steps of: accessing, with a web browser, a first host web-page hosted on a first server comprising one or more hyperlinks to other web-pages and/or web based resources; selecting/choosing a hyperlink present in the host web-page and identifying one or more associated web-pages and/or web based resources for the selected/chosen hyperlink; for each selected/chosen hyperlink displaying within the web browser, indicia of one or more associated web-pages and/or web based resources in proximity to the selected/chosen hyperlink, wherein the web browser renders the web-page content from the first server, and the indicia are rendered by a software module from a source separate from the host web-page, wherein the indicia comprise one or more links to the associated web-page(s) or resource(s).

Preferably where the method of the first aspect further comprising the display of related web-pages as described in the second aspect.

Optionally, wherein the software module is incorporated into the web browser, and/or herein the step of associating of the URI and/or hyperlinks is performed on a second server, and the method further comprises the steps of: forwarding the URI/web-pages to a second server, the second server comprising a database with a plurality of URIs/web-pages and a processor enabled to associate the forwarded URI/web-pages with one more of the URIs in the database; forwarding the associated URI/web-page to the software module to render on the host web-page.

Preferably, wherein the step of associating is performed on a user computer on which the web browser is used, the user computer further comprising a database with a plurality of URIs and a processor enabled to associate the first URI and/or selected/chosen hyperlinks with one more of the URIs in the database.

Optionally wherein the database comprises keywords associated with each URI and the step of associating comprises the steps of: identifying one or more keywords associated with the first URI and/or selected/chosen hyperlinks; identifying one or more different URIs/web-pages in the database which have the same or similar keywords.

Optionally wherein the keywords are identified through metadata and/or keyword identification of the content of the first web-page.

Preferably according to the second aspect of the invention, the indicia of the related hyperlinks are displayed in the web browser when a pointing device, such as a cursor, is on or near the selected/chosen hyperlink. Preferably wherein the link to the associated web-page or resource is a hyperlink or script which directs a browser to the web-page or resource.

Preferably, wherein the indicia of the related URI/web-page is an icon.

Preferably according to the first aspect of the invention, the indicia is placed above the address bar of the web browser.

There is also provided a computer readable medium comprising a set of instructions which when read by a computer provide the method described herein.

There is also provided a computer system comprising at least one computer with a processor,

the computer comprising a web browser, a software module and a display, wherein the computer is programmed so that when the web browser accesses a web-page hosted on a first server that is identified by a first URI; the first URI is associated with one or more different URIs or the computer receives one or more associated URIs associated with the first URI; displays indicia of the one or more associated URIs, on the display within the web browser, wherein the web browser renders the web-page content from the first server, and the indicia are rendered by a software module from a source separate from the host web-page, the indicia comprising a link to the associated URI.

There is also provided a computer system comprising at least one computer with a processor, the computer comprising a web browser, a software module and a display, wherein the computer is programmed so that when the web browser accesses a web-page hosted on a first server that hosted web-page comprises one or more hyperlinks to other web-pages; the one or more hyperlinks are associated with one or more different web-pages or the computer receives one or more associated web-pages associated with the hyperlinks; displays indicia of the one or more associated web-pages, on the display within the web browser, wherein the web browser renders the web-page content from the first server, and the indicia are rendered by a software module from a source separate from the host web-page, the indicia comprising one or more links to the associated web-page(s).

Preferably the computer system further comprising a second server, the second server comprising a database with a plurality of URIs/web-pages and a processor configured to associate the forwarded URI/web-pages with one more of the URIs in the database; wherein the processor of the computer is programmed to forward the first URI or hyperlinks to the second server, the second server configured to forward the associated URI/web-page to the software module to render on the host web-page.

### BRIEF DESCRIPTION OF THE DRAWINGS

Further aspects, features and advantages of the invention will be apparent from the following description of preferred embodiments, presented by way of example only, and by reference to accompanying drawings wherein:

FIG. 1 is a schematic of the apparatus used according to an aspect of the invention;

FIG. 2 is a flow chart of the process according to a first embodiment of the invention;

FIG. 3 is a screenshot of a web-page with the invention according to the first embodiment;

FIG. 4 is a flow chart of the process according to a second embodiment of the invention; and

FIG. 5 is a screenshot of a web-page with the invention according to the second embodiment.

### DETAILED DESCRIPTION

The present invention enables the display of associated URIs on a web-page displayed by a browser. It does not require the creator of the web-page to insert specific code into the web-page or indeed for any communication with the host of the web-page.

In the present application the term URI is used to mean a string of characters used to identify a resource on the internet and encompasses both Uniform Resource Locators (“URL”) and Uniform Resource Names (“URN”).

Whilst the important function of a web-page hyperlink is to allow automatic movement from a source web-page to a target web-page the term “hyperlink” may be understood to refer to the usual implementation of such linking on the world wide web. The term “link” is used to also include alternative implementation such as a portion of web-page that when selected/clicked activates a script which in turn opens a further browser, the further browser automatically rendering the target web-page in accordance with the script.

In a first embodiment, there is provided a method which identifies related web-pages to the web-page that has been rendered on a web browser and displays to a user, in an unobtrusive manner, links to the related web-pages. In particular, the invention allows for the display of the related content links without the creator of the web-page having to amend their web-page or to embed any specific coding within the viewed web-page.

In a further related embodiment, there is provided a method which identifies a first hyperlink “embedded” in a web-page (i.e., coded into the web-page), for example, as a hypertext, identifies related hyperlinks to the first hyperlink and presents the related hyperlinks to the user. Therefore, (for example when a user places their cursor over, or near, the first hyperlink) they are presented with some indicia, which clicked upon, provides a hyperlink, or further hyperlinks which lead to related content, thereby giving the user the additional option as to which content they wish to view.

The links to related content or web-pages are typically to other web-pages. However, a link may also direct a browser to other forms of web based content or resources such as multimedia content, .pdf files etc.

The term related hyperlink or related content refers to different web-pages from the web-page being viewed, which typically, but not necessarily, have similar content. For example, if the viewed page contains a recipe a related hyperlink can link to a page that has a similar recipe (i.e., has similar content) or because of the choice of the third party, link to a website which sells cars (i.e., different content, but the hyperlink from the viewed recipe page to the destination car selling page means that they are related). Therefore, the decision of whether content is related may be made a third party who uses their judgement to decide if content is related. Alternatively, a decision on whether content is related may be made by a decision engine which follows a series of predefined rules. The association of a first website with a second website or resource is what makes the content related.

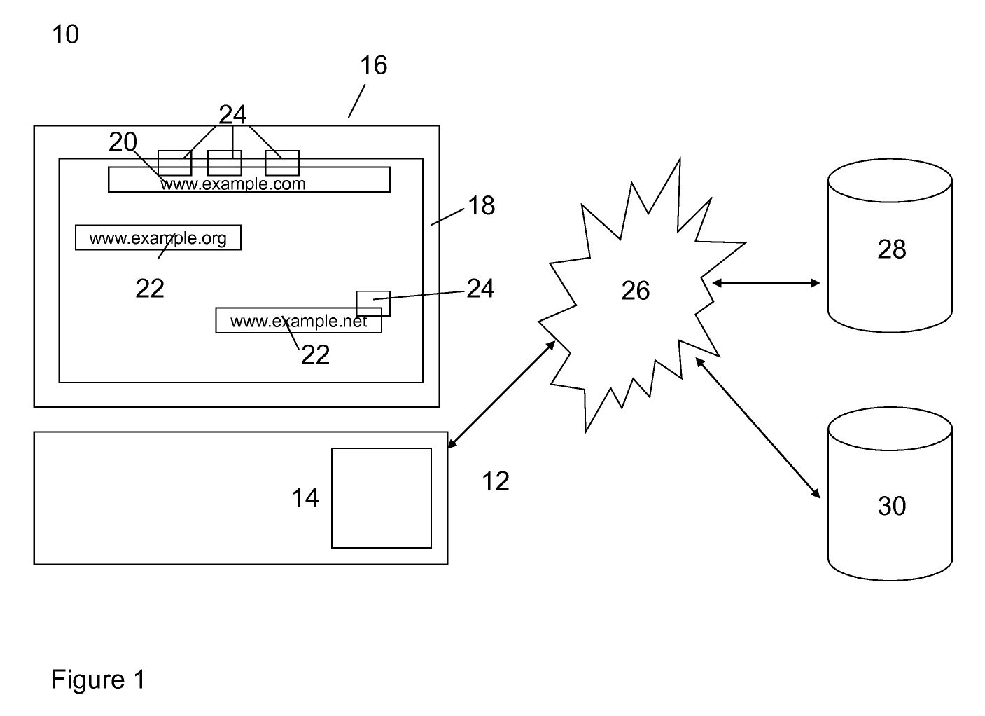

In FIG. 1 there is shown apparatus 10, in accordance with the invention. There is shown: user computer 12; display 16; web browser 18; the internet 26; a web content server 28 and a related content server 30.

The computer 12 comprises known features such as memory, processor (not shown) and a software module 14.

Each of the user computer 12, web content server 28 and related content server 30 are connected to the internet 26. The user computer 12 may communicate with both the web content server 28 and the connected content server 30 via the internet 26.

The web browser has address bar 20, and is displaying a web-page with the URI “www.example.com”. The space showing the displayed web-page includes a hyperlink 22 and also related content indicators 24.

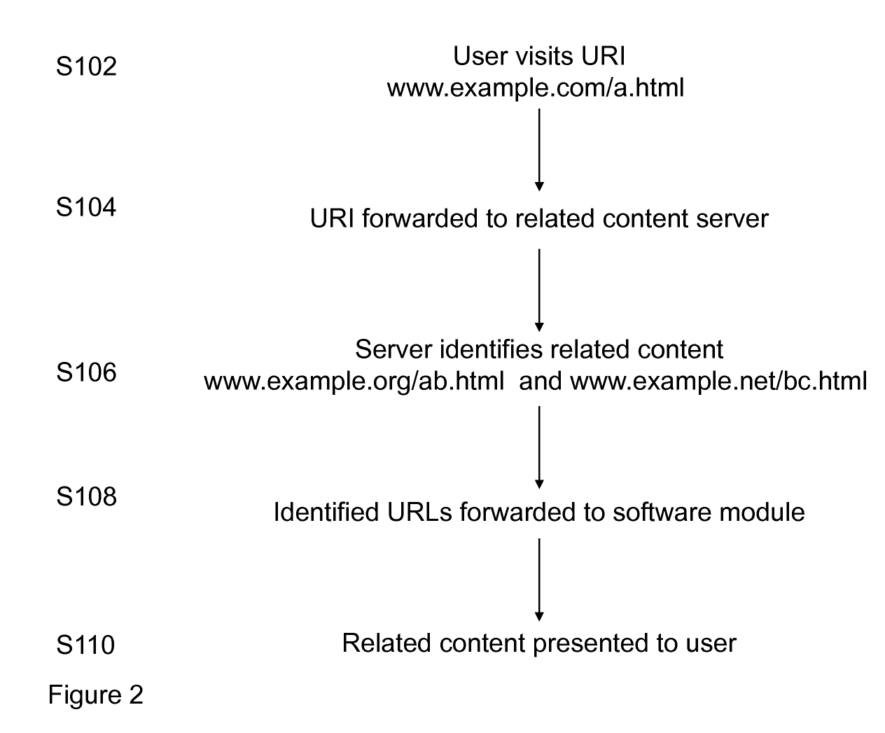

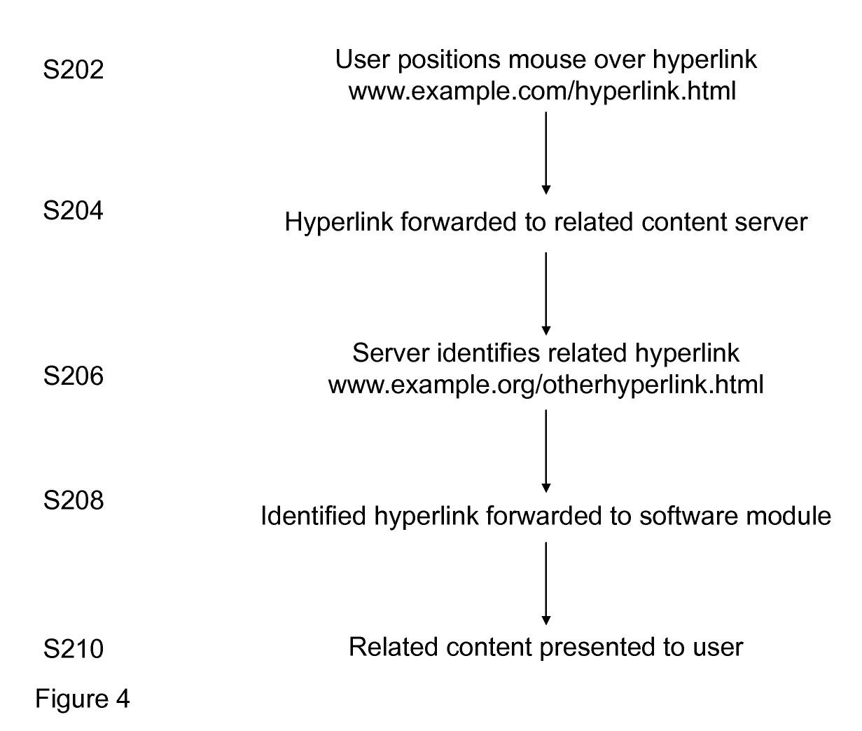

In use, a user operates the computer 12 in a known manner to view content from the web server 28 via the internet 26. The user computer 12 has installed on it a software module 14 with the functionality as described with reference to FIGS. 2 and 4. In a further embodiment, the software module 14 is incorporated in web browser, or stored on a different computer (e.g., a central server, not shown) or a different server (not shown) as is known in “cloud” computing.

The web browser 18 on the user computer 12 renders content from a web content server 28 in a known manner. The content from the web content server 28 is identified by a URI which is typically shown as a URI in the address bar 20 of the web browser 18. The content of the web-page sent from the content server 28 may also contain one or more hyperlinks 22, embedded in the code of the page.

In use, the URI of the web-page rendered on the web browser 18 and/or one or more of the hyperlinks 22 present in the web-page are forwarded by the software module 14 to the related content server 30. The related content server 30 for one or more of the URI and/or hyperlinks 22 identifies further, different, related web-pages.

For example, if the source web-page is from a news website, and shows content related to a particular story, say a report for a football match, related content may be other news websites reporting the same football match. The related content may also be stories that are related to the particular match e.g., a specific incident which occurred in the match, or an editorial comment related to the match.

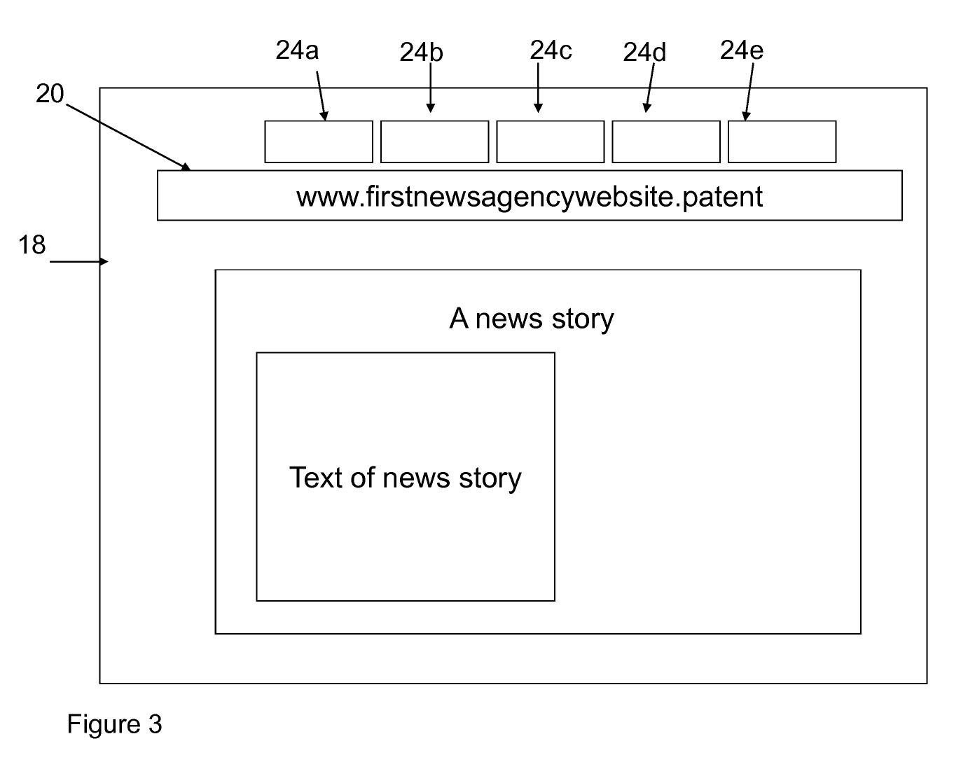

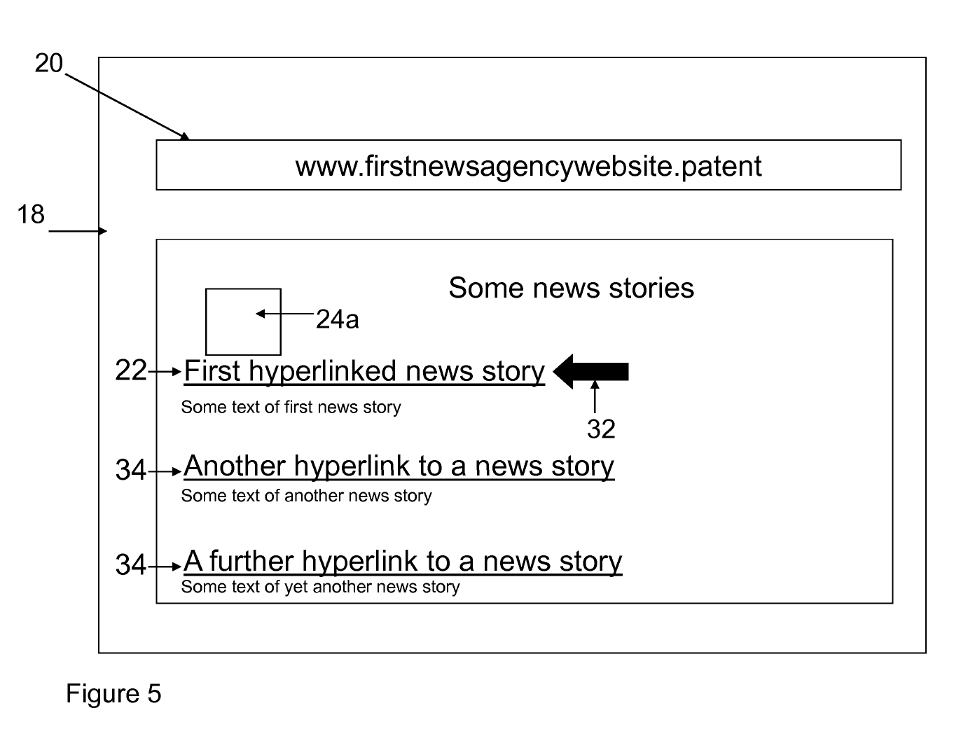

The identified related content is forwarded to the software module 14 by the related content server 30. References to identified related content are rendered on the web browser 18 as a related content indicator 24 over the displayed web-page. Such an indicator 24 may be an icon or floating hyperlink. Examples of the related content indicators 24 are shown in FIGS. 3 and 5. The indicators can appear as if they are part of the web-page and if desirable in some embodiments the user is not able to tell which of the hyperlink 22 and indicators 24 originated from the web content server 28 and which from the related content server 30.

The software module 14 therefore is enabled to forward information on the URI and hyperlinks being rendered by a web browser to the related content server 30. The module 14 is also enabled to receive information from the related content server 30 and to overlay indicia of related content on the viewed page delivered by the web browser 18 or operating system 16 interface. The software module 14 may be programmed in any suitable language.

In FIG. 2 there is shown the process of a user accessing a first web-page, identified by a URI, and being presented with links to related web-pages identified by their different URIs. As discussed above, a user wishing to view related content would typically have to access a search engine, identify search terms and search for related content to the content that is currently being viewed. This is typically unsatisfactory due to the time taken and also to the difficulties associated with the identification of search terms. The present method allows for the automatic provision of related web-pages and provides access to the related web-pages without having to leave the currently viewed web-page.

There is shown, a user visiting a first website at step S102. The website owner does not need to have any knowledge that the user has installed on their machine the software module 14 in order for the display of related content to occur. Importantly, the website owner is not required to input any specific source code into the web-page to enable the user to utilise the present invention. Therefore, the content from the web content server 28 is rendered in the normal manner.

The web-page visited at step S102 will have a URI associated with it. The URI is an identifier unique to the web-page. In the example shown the URI is www.example.com/a.html. The URI is shown in the address bar 20 of the web browser 18.

At step S104 the software module 14 forwards the URI to a dedicated related content server 30.

In an embodiment, the server 30 has a database which contains URIs and indicators of their content in the form of keywords. For example, a URI which is directed towards a news story the keywords would be those which identify the news story. For example, “UK,” “government” and “budget.” These keywords may be identified in a number of known ways, such as metadata tags in the web-page, automated keyword identifiers which analyse the content of the page etc.

The server 30 identifies other URIs which have identical or similar keywords and therefore would typically have the same content. This can be performed using known pattern matching or searching techniques.

In a further embodiment, content from URI can be manually identified and linked within the database. In this embodiment, the URI www.example.com/a.html will have been previously identified as being related to www.example.org/ab.html and www.example.net/bc.html and this relationship has been inputted into the database at the related content server 30.

In yet another embodiment, content from a web server can be automatically identified with content from one or more different web servers. For example, if the URI is a news story held on a first news agency web server, the related content for any story published on the first news agency website is the same story published on other, different, news agencies web servers.

In further embodiments, the association is performed at the user computer 12 using a database stored on the user computer 12. In this embodiment, the software module 14 is not required to forward the URI to the related content server 30. Preferably, the database stored locally on the user computer (or a different computer, if the user computer 12 is part of a network) is updated periodically to ensure that related content can be identified for new content. This is particularly relevant in the context of news stories.

At step S106, the related content server 30 identifies two URIs which are identified as being related to www.example.com/a.html, namely www.example.org/ab.html and www.example.net/bc.html. The identification of the related content can occur using any of the above discussed methods, or any suitable method.

At step S108, the identified URIs are forwarded from the related content server 30 to the software module 14 via the internet 26.

At step S110 the identified URIs are presented to the user on the web browser 18. In the preferred embodiment, the related URIs are shown in a discreet manner via a form of indicia.

The indicia are preferably in the form of small icons which are placed at or near the address bar 20 of the web browser 18. Preferably, such icons are placed so that they do not obscure the content of the web-page. In a preferred embodiment, the user is able to set the transparency of the icons displayed so that icons do not interfere with the user's experience of viewing the web-page. The icons are enabled so that on a click event the web browser is redirected towards the related URI. Preferably, the user can specify whether the related content is displayed in the existing browser or a new browser window. An example of the indicia is shown in FIG. 3. In a further embodiment, the indicia may take the form of underlined text listing the URI of the related web-page in a manner which is conventional for displaying hyperlinks.

The indicia are preferably overlaid over the viewed web-page, delivered by the web browser by the software module 14.

FIG. 3 shows an example of a web-page in which indicia of related URIs 24a -24e are shown above the address bar 20. There is shown the web-page as rendered in a web browser 18, the address bar 20 and related content indicators 24a to 24e.

In the example shown in FIG. 3 there are shown five different related content indicators 24a to 24e. The content from the web content server 28 is from a first news agency's website relating to a news story. The related content server 30 has identified five different websites which have related content (in this case the same story) and identifies these websites via indicators 24a-24e as icons. The icons represent to the user where the related content is hosted. The example shown in FIG. 3 indicators 24a to 24e are generic shapes which are taken to represent different content providers. In further examples, the indicators may be a trademarked logo or device associated with the content provider or a visual indicator associated with the content provider. Therefore, the user is able to identify the host website of the related content.

In the example shown, the indicators 24a-24e are placed away from the content of the web-page so as not to impact the user's experience of viewing the web-page. In further examples, the related content indicators 24 are placed in other positions on the web-page. The position of the indicators 24 can be changed according to user preference, though preferably this should not obscure the content of the web-page.

An advantage of providing the indicia above the address bar is that it is one area of a browser that it generally unaffected by user settings and therefore the placement of the indicia should be consistent across different computers.

FIG. 4 shows a flow chart of the process of identifying related hyperlinks according to an aspect of the invention.

The process discussed with reference to FIG. 4 can occur with or separately to the process discussed with reference to FIG. 2. The process in FIG. 2 discusses the identification of related content based on the URI that is viewed by the web browser 18. In the process discussed below a first hyperlink is identified within the web-page (which has been coded into the web-page by the web-page creator) and hyperlinks with content related to the first hyperlink are identified and shown in the web browser 18.

For example, if a web-page shows a news story which makes reference to an earlier story often such a reference will be made with a hyperlink which is coded into the web-page, allowing the user to view the earlier story if desired. In the embodiment discussed, related subject matter hyperlinks are also presented to the user, e.g., hyperlinks to other websites reporting the same earlier story, thereby enabling the user to view different web-pages which have subject matter related to the first hyperlink that is present in the web-page (though as discussed above, in a further embodiment, the content of the related page that the hyperlink directs the browser 18 to, is of a different subject matter to the subject matter shown on the web-page). Previously, if a user wanted to view related content to the hyperlink, they would typically have to access a search engine, identify relevant search terms to enter into the search engine and access the results.

There is shown the user visiting a first web-page which contains one or more hyperlinks at step S202. The user views the website in their web browser 18 in the normal manner. During their viewing of the website they may move the cursor over or near an embedded hyperlink. Such an event may be simply to place the cursor on, or near, the hyperlink. Such events are detected by the software module 14 and the hyperlink 22, in the example shown in FIG. 4 www.example.com/hyperlink.html, is forwarded to the related content server 30 at step S204. In a further embodiment, all hyperlinks 22 are identified and forwarded to the related content server 30 whenever a web-page is loaded.

At step S206 related hyperlinks are identified for the hyperlink(s) forwarded at step S204. The process of identifying the related content is as described in FIG. 2 at step S106 for the identification of related URIs from a first URI. In the example shown, one related hyperlink has been identified, namely
www.example.org/otherhyperlink.html.

The identified related hyperlink(s) is forwarded to the software module 14 at step S208 and indicia relating to the hyperlink 24, is overlaid on the web browser near the original hyperlink 22 at step S210. These steps are as steps S108 and S110 in FIG. 2. Therefore, an indicia 24 of the related hyperlink, www.example.org/otherhyperlink.html, is shown near the original embedded hyperlink www.example.com/hyperlink.html.

For reasons of ease of use and user experience, it is found that it is preferable to only display the related content indicators 24 when the user has placed the cursor on or near the hyperlink 22. This allows the user to choose whether he wishes to be presented with connected hyperlinks.

FIG. 5 shows an example of the related content indicator 24a placed next to a hyperlink. There is shown the web browser 18, address bar 20, the first hyperlink 22, the related content indicator 24a, a cursor 32 and further hyperlinks 34. The related content indicator 24a and cursor 32 are shown exaggerated for ease of reference.

The cursor 32 is on the first hyperlink 22 entitled “First hyperlinked news story.” The presence of the cursor 32 on or near the first hyperlink 22 has initiated the process described in FIG. 4. At step S206 of the process one related hyperlink has been identified and the indicator 24a is overlaid on the browser 18. In the example shown indicator 24a is an icon of a first, different, news agency indicating that the related hyperlink would send the user to that first new agency's website. If more than one related hyperlink was identified at step S206 there would be more than one related content indicator 24a . . . 24e shown near the first hyperlink 22. As the cursor 32 in FIG. 5 is not on or near the further hyperlinks 34 no related content indicators 24a . . . 24e are shown for the further hyperlinks 34.

The maximum number of URI connected web-pages and embedded hyperlink connected hyperlinks displayed can be configured by the user.

The foregoing merely illustrates the principles of this invention, and various modifications can be made by persons of ordinary skill in the art without departing from the scope and spirit of this invention.

1. A computer implemented method comprising the steps of:
accessing, with a web browser, a first web-page hosted on a first server, the web-page identified by a first URI;
associating the first URI with one or more different URIs; and
displaying indicia within the web browser of the one or more associated URIs, wherein the web browser renders the web-page content from the first server, and the indicia is rendered by a software module from a source separate from the host web-page, the indicia comprising a link to the associated URI.

2. The method of claim 1, further comprising:
accessing, with a web browser, a first host web-page hosted on the first server comprising one or more hyperlinks to other web-pages and/or web based resources;
choosing one or more of the hyperlinks present in the host web-page and identifying one or more associated web-pages and/or web based resources for the chosen hyperlink; and
for each chosen hyperlink displaying within the web browser indicia of the one or more associated web-pages and/or web based resources in proximity to the chosen hyperlink, wherein the web browser renders the web-page content from the first server, and the indicia is rendered by a software module from a source separate from the host web-page,
wherein the indicia comprises one or more links to the associated web-page(s) or resource(s).

3. The method of claim 1, wherein the software module is incorporated into the web browser.

4. The method of claim 1, wherein the step of associating of the URI and/or hyperlinks is performed on a second server, and the method further comprises the steps of:
forwarding the URI/web-pages to a second server, the second server comprising a database with a plurality of URIs/web-pages and a processor enabled to associate the forwarded URI/web-pages with one more of the URIs in the database;
forwarding the associated URI/web-page to the software module to render on the host web-page.

5. The method of claim 4, wherein the database comprises keywords associated with each URI and the step of associating comprises the steps of:
identifying one or more keywords associated with the first URI and/or chosen hyperlinks;
identifying one or more different URIs/web-pages in the database which have the same or similar keywords.

6. The method of claim 5, wherein the keywords are identified through metadata and/or keyword identification of the content of the first web-page.

7. The method of claim 1, wherein the step of associating is performed on a user computer on which the web browser is used, the user computer further comprising a database with a plurality of URIs and a processor enabled to associate the first URI and/or chosen hyperlinks with one more of the URIs in the database.

8. The method of claim 1, wherein the indicia or the related URI/web-page is an icon.

9. The method of claim 1, wherein the indicia is placed above the address bar of the web browser.

10. A computer readable medium comprising a set of instructions which when read by a computer provide the method of claim 1.

11. A computer implemented method comprising the steps of:
accessing, with a web browser, a first host web-page hosted on a first server comprising one or more hyperlinks to other web-pages and/or web based resources;
choosing one or more of the hyperlinks present in the host web-page and identifying one or more associated web-pages and/or web based resources for the chosen hyperlink; and
for each chosen hyperlink displaying within the web browser indicia of the one or more associated web-pages and/or web based resources in proximity to the chosen hyperlink, wherein the web browser renders the web-page content from the first server, and the indicia is rendered by a software module from a source separate from the host web-page,
wherein the indicia comprises one or more links to the associated web-page(s) or resource(s).

12. The method of claim 11, wherein the indicia of the related hyperlinks is displayed in the web browser when a pointing device, such as a cursor, is on or near the chosen hyperlink.

13. The method of claim 11, wherein the link to the associated web-page or resource is a hyperlink or script which directs a browser to the web-page or resource.

14. A computer system comprising at least one computer with a processor,
the computer comprising a web browser, a software module and a display,
wherein the computer is programmed so that when the web browser accesses a web-page hosted on a first server that is identified by a first URI;
the first URI is associated with one or more different URIs or the computer receives one or more associated URIs associated with the first URI;
displays indicia of the one or more associated URIs, on the display within the web browser, wherein the web browser renders the web-page content from the first server, and the indicia is rendered by a software module from a source separate from the host web-page,
the indicia comprising a link to the associated URI.

15. The computer system of claim 14, further comprising a second server, the second server comprising a database with a plurality of URIs/web-pages and a processor configured to associate the forwarded URI/web-pages with one more of the URIs in the database; wherein the processor of the computer is programmed to forward the first URI or hyperlinks and to the second server, the second server configured to forward the associated URI/web-page to the software module to render on the host web-page.

16. A computer system comprising at least one computer with a processor, the computer comprising a web browser, a software module and a display, wherein:
the computer is programmed so that when the web browser accesses a web-page hosted on a first server that hosted web-page comprises one or more hyperlinks to other web-pages;
the one or more hyperlinks are associated with one or more different web-pages or the computer receives one or more associated web-pages associated with the hyperlinks;
displays indicia of the one or more associated web-pages, on the display within the web browser, wherein the web browser renders the web-page content from the first server, and the indicia is rendered by a software module from a source separate from the host web-page,
the indicia comprising one or more links to the associated web-page(s).

17. The computer system of claim 16, further comprising a second server, the second server comprising a database with a plurality of URIs/web-pages and a processor configured to associate the forwarded URI/web-pages with one more of the URIs in the database; wherein the processor of the computer is programmed to forward the first URI or hyperlinks and to the second server, the second server configured to forward the associated URI/web-page to the software module to render on the host web-page.
